(19) United States
(12) Patent Application Publication
(10) Pub. No.: US 2022/0012666 A1
(43) Pub. Date: Jan. 13, 2022

(54) System and Method for Optimum Alternative Recommendation for Personal Productivity Efficiency

(71) Applicant: International Business Machines Corporation, Armonk, NY (US)

(72) Inventors: Zachary A. Silverstein, Jacksonville, FL (US); Shikhar Kwatra, Durham, NC (US); Sarbajit K. Rakshit, Kolkata (IN)

(21) Appl. No.: 16/924,514

(22) Filed: Jul. 9, 2020

(51) Int. Cl. G06Q 10/06; G06F 16/906

(52) U.S. Cl. CPC G06Q 10/06398; G06F 16/906

(57) ABSTRACT

A method, system, and computer-usable medium are disclosed for recommending an alternative activity to a user. Information is received from a plurality of sources related to the user, information includes a set of activities, a duration D and a measurement of productivity associated with the activities P, each activity has the duration and the productivity. A clustered and classified sets of activities A is received, that comprise the information applied with a clustering algorithm to associate a cluster of types of activities and productivity associated with the cluster of types of activity with a recommended continuous time duration. Responsive to detecting a current activity exceeding the recommended continuous time duration and an indication of a reduction of productivity for the current activity, an alternative activity is recommended to the user.

### BACKGROUND OF THE INVENTION

### Field of the Invention

The present invention relates in general to the field of computers and similar technologies, and in particular to software utilized in this field. Still more particularly, it relates to a method, system and computer-usable medium for personal productivity and alternative activity recommendation as personal productivity efficiency.

### Description of the Related Art

People seek to be efficient at whatever they may do, at work, in learning/education, personal improvement, etc. Furthermore, there is a desire for individuals to maximize their productivity. For many people, the simple answer, which typically leads to long term negative results, is to just work harder at maximum levels. This can lead to burn out and oftentimes poor work product results.

When people lose their focus or get bored, their efficiency slips, and they can become counterproductive from mistakes. To avoid getting burnout and to sometimes refresh oneself, a person may take a break or distraction. In fields where creativity is important, taking such breaks may be necessary to clear one's mind and to come up with different ideas. Breaks and distractions at certain times can benefit overall productivity.

Although breaks and distractions may be helpful to stay productive, taking breaks or distractions at certain times can also be counterproductive. Sometimes a break is taken too early or at the wrong time, and a person gets derailed from performing their tasks. Sometimes a distraction is counterproductive. For example, for certain people going out for coffee or to exercise can lead to loss of focus as to performing jobs. The challenge is to determine when breaks and distractions are helpful to maximize personal productivity.

### SUMMARY OF THE INVENTION

A method, system, and computer-usable medium are disclosed for recommending an alternative activity to a user. Information is received from a plurality of sources related to the user, information includes a set of activities A (A₁, A₂, . . . , Aₙ), a duration D (D₁, D₂, . . . , Dₙ), and a measurement of productivity associated with the activities P (P₁, P₂, . . . , Pₙ), each activity Aᵢ has the duration Tᵢ and the productivity Pᵢ. A clustered and classified sets of activities A is received, that comprise the information applied with a clustering algorithm to associate a cluster of types of activities and productivity associated with the cluster of types of activity with a recommended continuous time duration. Responsive to detecting a current activity exceeding the recommended continuous time duration and an indication of a reduction of productivity for the current activity, an alternative activity is recommended to the user.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a computer network environment that includes a knowledge management system;

FIG. 2 is a simplified block diagram of an information handling system capable of performing computing operations described herein;

FIG. 3 is a simplified block diagram of a system for personnel productivity and recommendation as to personal productivity efficiency;

FIG. 4 is a generalized flowchart for implementing personnel productivity and recommendation as to personal productivity efficiency; and

FIG. 5 is a generalized flowchart for recommending an alternative activity based on an inefficiency criteria.

### DETAILED DESCRIPTION

The present application relates generally to personnel productivity and alternative activity recommendation that can help with overall personal productivity. Implementations provide for capturing users' focus and detecting when focus crosses a productivity threshold. Such efficiency information can be implemented with one or more key performance indicators (KPI) based on related activities, such as software code writing/contribution, biometric tracking such as eye tracking, active time performing an activity, etc. Workload of users is classified based on user action and activities. Activities can be productive activities or be breaks from productive activities termed as “distractions.” Types of activities can be clustered as to what a user is doing based on a method such as “K-means” or fuzzing clustering, which for example can range from detecting an active activity and clustering based on the activity to an in-depth clustering based on brain activity mapping.

An optimum distraction or alternative activity that a user can do is identified, which can be recommended. If user's efficiency falls beneath a threshold of statistical significance during a period, such as a workday, a recommendation can be made as to an activity/break (distraction) that has a high average post-activity output score on each cluster. Based on information, such as metadata and determined effects on productivity, recommendation as to distractions or activity can be adjusted. The effects can be tracked after a user is notified of a given activity/activity type to verify the increase/decrease of performance on a given cluster.

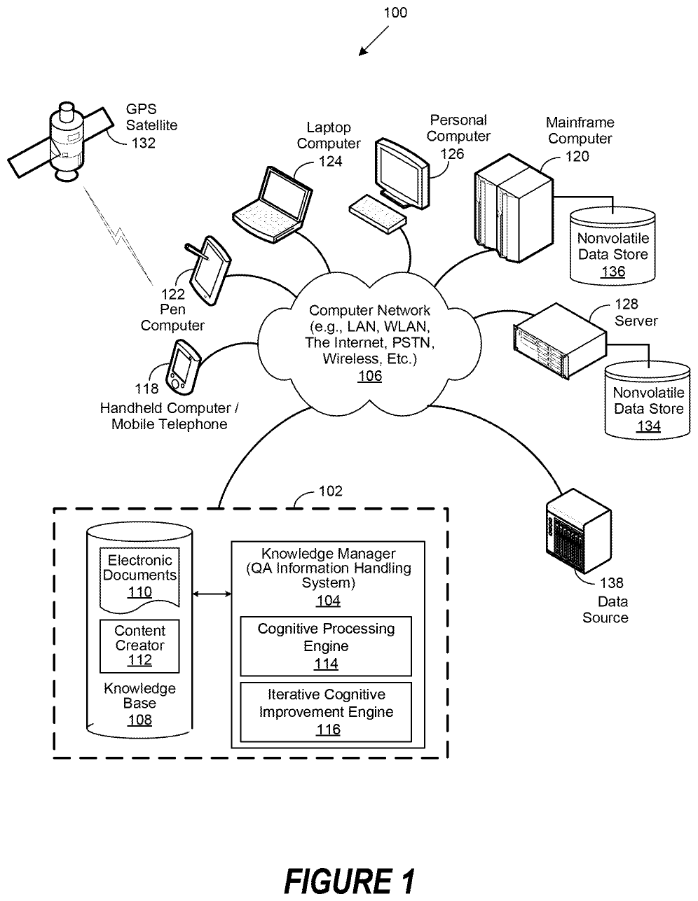

FIG. 1 depicts a schematic diagram of one illustrative embodiment of a computer network environment that supports the systems and methods described herein. In particular, the computer network environment 100 provides for a knowledge management system 102 which is instantiated in computer network environment 100. An example of question/answer generation which may be used in conjunction with the principles described herein is described in U.S. Patent Application Publication No. 2011/0125734, which is herein incorporated by reference in its entirety.

The knowledge management system 102 may include a knowledge manager (question and answering information handling system) computing device 104 that includes one or more processors and one or more memories, and potentially any other computing device elements generally known in the art including buses, storage devices, communication interfaces, and the like) connected to a network 106. The network 106 may include multiple computing devices in communication with each other and with other devices or components via one or more wired and/or wireless data communication links, where each communication link may comprise one or more of wires, routers, switches, transmitters, receivers, or the like.

The knowledge management system 102 and the computer network environment 100 may enable question and answer (QA) generation functionality for one or more content users. Other embodiments of knowledge management system 102 may be used with components, systems, sub-systems, and/or devices other than those that are depicted herein.

Knowledge manager computing device 104 may be configured to receive inputs from various sources. For example, knowledge manager computing device 104 may receive input from the network 106, a knowledge base 108 which can include a corpus of electronic documents 110 or other data, a content creator 112, content users, and other possible sources of input. In various embodiments, the other possible sources of input can include location information. In one embodiment, some, or all of the inputs to knowledge manager computing device 104 may be routed through the network 106. The various computing devices on the network 106 may include access points for content creators and content users. Some of the computing devices may include devices for a database storing the corpus of data. The network 106 may include local network connections and remote connections in various embodiments, such that the knowledge management system 102 may operate in environments of any size, including local and global, e.g., the Internet. Additionally, knowledge manager computing device 104 serves as a front-end system that can make available a variety of knowledge extracted from or represented in documents, network-accessible sources, and/or structured data sources. In this manner, some processes populate the knowledge manager with the knowledge manager also including input interfaces to receive knowledge requests and respond accordingly.

In one embodiment, the content creator 112 creates content in electronic documents 110 for use as part of a corpus of data with knowledge manager computing device 104. The electronic documents 108 may include any file, text, article, or source of data for use in knowledge management system 102. Content users may access knowledge management system 102 via a network connection or an Internet connection (represented as to the network 106) and may input questions to knowledge management system 102 that may be answered by the content in the corpus of data. As further described below, when a process can implement a query with exclusion criteria from the knowledge manager. Certain embodiments provide for Natural Language Processing (NLP), such that knowledge management system 102 can be considered as an NLP system, which in certain implementations performs the methods described herein. In one embodiment, the process sends queries in the form of natural language questions, etc.) to the knowledge manager computing device 104. Knowledge manager computing device 104 may interpret questions/queries and provide a response to the content user containing one or more answers/results to the questions/queries. In some embodiments, knowledge manager computing device 104 may provide a response to users in a ranked list of answers. Certain embodiments provide for knowledge manager computing device 104 to include a cognitive processing engine 114 and iterative cognitive improvement engine 116, which are further described herein. In certain embodiments, the knowledge management system 102 is provided as a cloud computing service.

One such knowledge management system 102 is the IBM Watson™ system available from International Business Machines (IBM) Corporation of Armonk, N.Y. The IBM Watson™ system is an application of advanced natural language processing, information retrieval, knowledge representation and reasoning, and machine learning technologies to the field of open domain question answering. The IBM Watson™ system is built on IBM's DeepQA technology used for hypothesis generation, massive evidence gathering, analysis, and scoring. DeepQA takes an input question, analyzes it, decomposes the question into constituent parts, generates one or more hypothesis based on the decomposed question and results of a primary search of answer sources, performs hypothesis and evidence scoring based on a retrieval of evidence from evidence sources, performs synthesis of the one or more hypothesis, and based on trained models, performs a final merging and ranking to output an answer to the input question along with a confidence measure.

In some illustrative embodiments, knowledge manager computing device 104 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input question and the language used in each of the portions of the corpus of data found during the application of the queries using a variety of reasoning algorithms. There may be hundreds, or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

Types of information handling systems that can utilize computer network environment 100 range from small handheld devices, such as handheld computer/mobile telephone 118 to large mainframe systems, such as mainframe computer 120. Examples of handheld computer 118 include personal digital assistants (PDAs), personal entertainment devices, such as MP3 players, portable televisions, and compact disc players. Other examples of information handling systems include pen, or tablet, computer 122, laptop, or notebook, computer 124, personal computer system 126, and server 128. In certain embodiments, the location information is determined through the use of a Geographical Positioning System (GPS) satellite 132. In these embodiments, a handheld computer or mobile telephone 116, or other device, uses signals transmitted by the GPS satellite 132 to generate location information, which in turn is provided via the network 106 to the knowledge manager system 102 for processing. As shown, the various information handling systems can be networked together using network 106. Types of network 106 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 128 utilizes nonvolatile data store 134, and mainframe computer 118 utilizes nonvolatile data store 136. The nonvolatile data store 134 can be a component that is external to the various information handling systems or can be internal to one of the information handling systems. Furthermore, a data store 138 is provided in computer network environment 100.

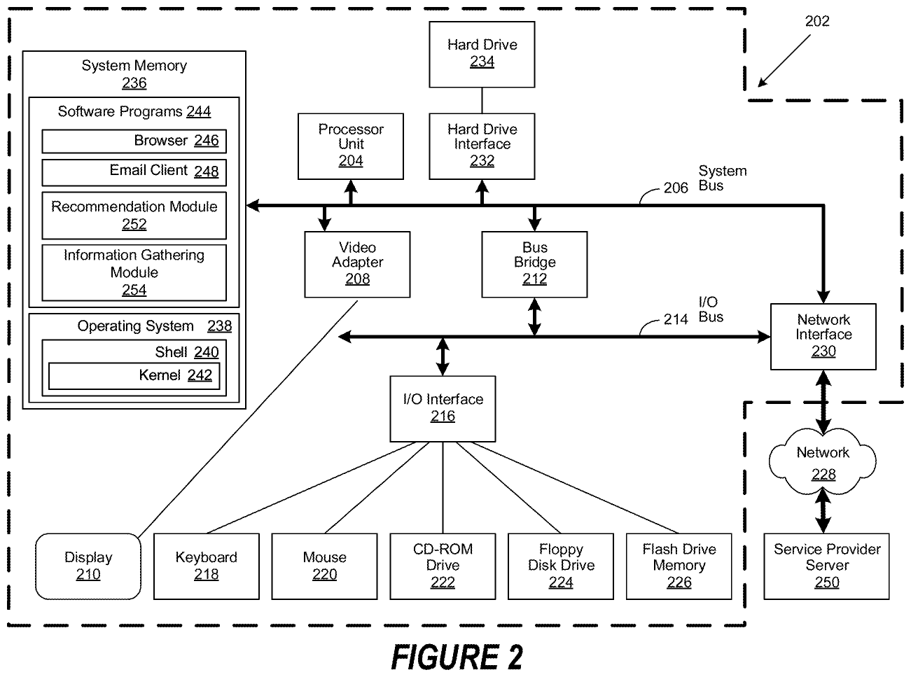

An illustrative example of an information handling system showing an exemplary processor and various components commonly accessed by the processor is shown in FIG. 2. FIG. 2 illustrates an information processing handling system 202, more particularly, a processor and common components, which is a simplified example of a computer system capable of performing the computing operations described herein. Information processing handling system 202 includes a processor unit 204 that is coupled to a system bus 206. A video adapter 208, which controls a display 210, is also coupled to system bus 206. System bus 206 is coupled via a bus bridge 212 to an Input/Output (I/O) bus 214. An I/O interface 216 is coupled to I/O bus 214. The I/O interface 216 affords communication with various I/O devices, including a keyboard 218, a mouse 220, a Compact Disk-Read Only Memory (CD-ROM) drive 222, a floppy disk drive 224, and a flash drive memory 226. The format of the ports connected to I/O interface 216 may be any known to those skilled in the art of computer architecture, including but not limited to Universal Serial Bus (USB) ports.

The information processing information handling system 202 is able to communicate with a service provider server 250 via a network 228 using a network interface 230, which is coupled to system bus 206. Network 228 may be an external network such as the Internet, or an internal network such as an Ethernet Network or a Virtual Private Network (VPN). Using network 228, client computer 202 is able to use the present invention to access service provider server 250.

A hard drive interface 232 is also coupled to system bus 206. Hard drive interface 232 interfaces with a hard drive 234. In a preferred embodiment, hard drive 234 populates a system memory 236, which is also coupled to system bus 206. Data that populates system memory 236 includes the information processing information handling system's 202 operating system (OS) 238 and software programs 244.

OS 238 includes a shell 240 for providing transparent user access to resources such as software programs 244. Generally, shell 240 is a program that provides an interpreter and an interface between the user and the operating system. More specifically, shell 240 executes commands that are entered into a command line user interface or from a file. Thus, shell 240 (as it is called in UNIX®), also called a command processor in WINDOWS®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 242) for processing. While shell 240 generally is a text-based, line-oriented user interface, the present invention can also support other user interface modes, such as graphical, voice, gestural, etc.

As depicted, OS 238 also includes kernel 242, which includes lower levels of functionality for OS 238, including essential services required by other parts of OS 238 and software programs 244, including memory management, process and task management, disk management, and mouse and keyboard management. Software programs 244 may include a browser 246 and email client 248. Browser 246 includes program modules and instructions enabling a World Wide Web (WWW) client (i.e., information processing information handling system 202) to send and receive network messages to the Internet using Hyper Text Transfer Protocol (HTTP) messaging, thus enabling communication with service provider server 250. In various embodiments, software programs 244 includes a recommendation module 252 and an information gathering module 254, which are further described herein.

The hardware elements depicted in the information processing information handling system 202 are not intended to be exhaustive, but rather are representative to highlight components used by the present invention. For instance, the information processing information handling system 202 may include alternate memory storage devices such as magnetic cassettes, Digital Versatile Disks (DVDs), Universal Serial Bus (USB) drives, Secure Digital (SD) cards, Solid State Drive (SSD), and the like. These and other variations are intended to be within the spirit, scope, and intent of the present invention.

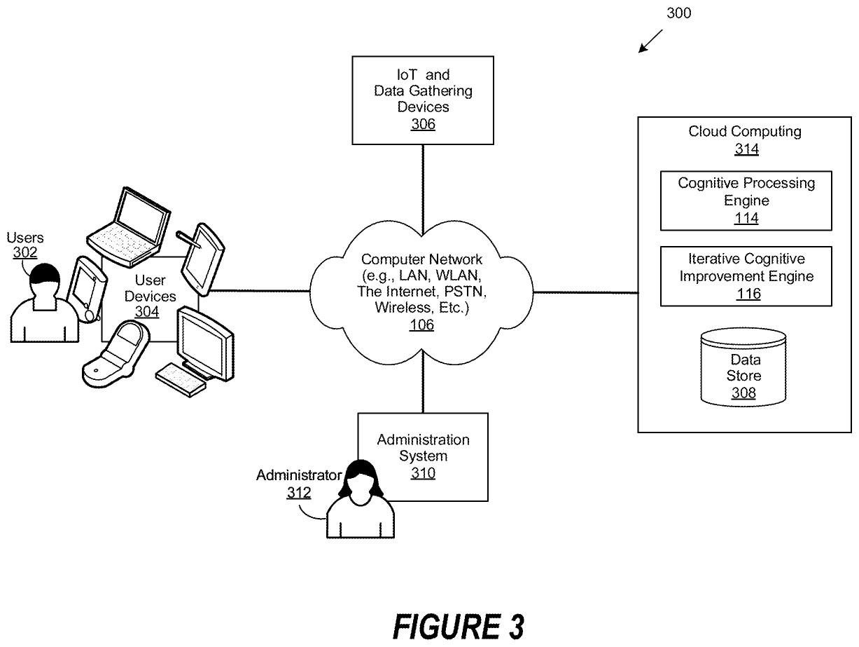

FIG. 3 shows a system capable of implementing the described operations and methods. In particular, the system 300 provides for personnel productivity and recommendation as to work efficiency. The system 300 includes the network 106 described above, which connects multiple users 302 through user devices 304 to various other devices and systems, etc. as further described herein. In particular, a user device 304 can be implemented as information handling system 202 and includes recommendation module 252 and information gathering module 254, as described in FIG. 2. It is to be understood, that user device 304 can include all or some of the described elements of information handling system 202. Examples of user device 304 can include a personal computer, a laptop computer, a tablet computer, a personal digital assistant (PDA), a smart phone, a mobile telephone, smart watch (i.e., wearables), or other device that is capable of communicating and processing data.

The system 300 includes a cloud computing system 306 which in certain implementations is knowledge management system 102. In particular, cloud computing system 306 includes cognitive processing engine 114 and iterative cognitive improvement engine 116 described in FIG. 1. Various embodiments further provide cloud computing system 306 to include a data store 308. The cognitive processing engine 114 can capture length of time activity and post recommendation performance, which can be stored in data store 308 as metadata and fed back to and used by cognitive processing engine 114 to optimize a recommended alternative activity and length of time. The computing system 314 detects an optimum alternative activity with respect to time and a current undertaken activity. A learning loop is created by the metadata being fed back the cognitive processing engine 114.

The system 300 further can include IoT and gathering devices 310. The IoT and gathering devices 310 can include hardware and software gathers biometric performance data. The user devices 304 and IoT and gathering devices 310 can be considered as sources of information related to activities performed by users 302. The information from these sources relate to user 302 includes a set of activities “A” defined as (A₁, A₂, . . . , Aₙ), a duration “D”, which is elapsed time, defined as (D₁, D₂, . . . , Dₙ), and a measurement of productivity associated with the activities “P” defined as (P₁, P₂, . . . , Pₙ) wherein the each activity Aᵢ has the duration Tᵢ and the productivity Pᵢ.

In particular, user devices 304 and IoT and gathering devices 310 provide information as to focus of users 302. Focus can be based on one or more key performance indicators (KPI). Examples of a KPI can include code commits (when developing software code), typing words per minutes, time on a mobile device, etc.

As described, the information gathering module 254 can be implemented on user devices 304 and IoT and data gathering devices 306. In particular, information gathering module 254 captures activities in which a user 302 is undertaking and classifies the activities into different categories and clusters. The information gathering module 254 can be implemented to classify workload of users 302 based on an undertaken operation, such as using a software application, on user devices 304 and/or IoT and data gathering devices 306. Such classification can include classification interaction with a software application, such as an amount of time an application is open/used, type of interaction with the application (e.g., reading vs. writing). Classification can be also directed to user device 304 and/or IoT and data gathering device 306 activity, such as usage, chat transcription and interaction, etc. Another example of classification can include calendar and productivity tool integration, such as checklist items, calendar meeting topics, etc.

Received data and information from user devices user devices 304 and IoT and gathering devices 310 can be clustered by information gathering module 254, for example, around categories to determine the type of activity and low or high level skills associated with the activity. The clustering can be manually trained based on users 302 interaction and inputs to a given user device 304 or IoT and data gathering device 306 as described above, or machine derived. Examples of activities can include word processing, research, coding development, meetings/collaboration time, back office work, etc. Types of activities can be clustered as to what a user is doing based on a method or clustering algorithm such as “K-means” or fuzzing clustering, which for example can range from detecting an active activity and clustering based on the activity to an in-depth clustering based on brain activity mapping.

The information gathering module 254 can be configured to detect the type of activity users 302 are undertaking. For example, information gathering module 254 can be configured to perform application/software analysis. Certain implementations can provide for integration into pre-existing support software and track the amount of time users spend on certain tasks. Implementations of information gathering module 254 can provide for generalized application analysis, such as top level usage, performance, and active page/window analysis on certain platforms which capture artifacts the user is interacting with. Implementations of information gathering module 254 can also provide to detect users 302 interactions with other devices, such as mobile devices and other possible devices that are connected to the system cloud computing system 314.

As described above, the recommendation module 252 is implemented on user devices 304. The recommendation module 252 can also be implemented on IoT and gathering devices 310. The recommendation module 252, also considered as an alternative activity module, can be configured to identify current activity or alternative activities (e.g., distractions) user 302 is doing or can do based on a predefined list face on in ad hoc activity detection via personal device (e.g., IoT device), where such activity may be going on a walk, taking part in a sports game, getting coffee, etc.

Various embodiments provide for the system 300 to include an administrative system 310, which is accessed and controlled by an administrator 312. The administrative system 310 can be implemented as information handling systems and connected to the network 106.

Various implementations provide for user devices 304 and IoT and data gathering devices 306 to continuously track users 302 performance and interaction with the various platforms of user devices 304 and IoT and data gathering devices 306 to determine users 302 focus and productivity. Focus and productivity can be metric based, such as writing a certain number of lines of code for a software developer. Focus and productivity can be biometric associated such as eye-focus (e.g., how long is user 302 looking at a screen).

In certain implementations when a user device 304 or IoT and data gathering device 306 focus of a user 302 falling beneath threshold “T”, where “T” can be defined as a level set manually (e.g., by administrator 312) or derived statistically. Such a level “T” is determinative of an action for remediation or change in an activity of user 302. The threshold “T” can include time factors, for example, a user 302 that is inactive for five minutes is not given a feedback, while user 302 being inactive for an hour is given a feedback.

Certain implementations provide for the cloud computing system 314 to ameliorate or improve activity recommendation when a user 302 reaches threshold “T.” When such focus disruption is determined, the iterative cognitive improvement engine 116 gathers the following data. Interaction data as to activity a user 302 is currently performing, schedule to perform (e.g., daily schedule activity), or an activity that the 302 is struggling with. Historical data relates to activities (distractions) that had the most positive effect for a given situation and user 302 as to particular focus issues. The amount of time that would be needed can be considered.

In certain implementations, cloud computing system 314 and the iterative cognitive improvement engine 116, in particular, advises the user 302 as to the amelioration or improvement, and updates historical data as described above. Certain implementations provide for a “push” of the notification to the user 303. In certain implementations, a determination is made if the user 302 accepted the improvement, such as detecting biometric data from user devices 304 and/or IoT and data gathering devices 306, such as a detection of the user 302 biking, walking, etc. after a recommendation to exercise. In certain implementations, metadata for certain distractions are captured and stored temporarily for a given time period. As a user 302 returns to an activity or work related task from which they were recommended to replace with a distraction, change in performance metrics can be captured stored for the particular user 302 as historical data.

It is to be understood that other embodiments and implementations are possible. For example, recommended activities can be based on features such as a social score or other users that are available for a distraction activity/event. Distraction activities can be recommended base on a higher priority or not 100% optimal time, when a coworker (other user) who is net positive for the user is on another distraction activity. Break (distraction) types can be captured with respect to a user or user's current activity. For example, a user goes for a jog and is tired the rest of the day and productive output is decreased and as opposed to the user going for a walk and is energized to go back to being productive after the walk. For example, a user goes for a walk and the walk positively impacts emails sent, while the same user reading a book improves the activity of code development.

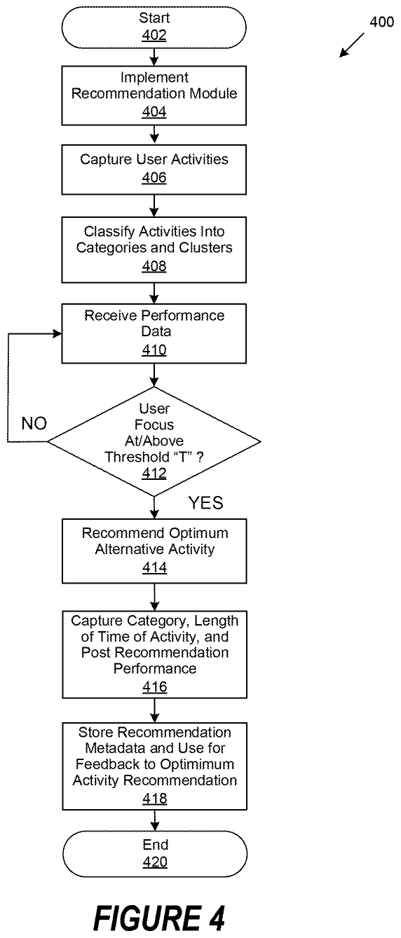

FIG. 4 is a generalized flowchart 400 for implementing personal productivity and recommendation as to alternative activities to increase personal productivity efficiency. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At step 402, the process 400 starts. At step 404, user 302 implements recommendation module 252 and information gathering module 254 on user devices 304 and/or IoT and data gathering devices 306 and accepts service from the cloud computing system 306.

At step 406, information gathering module 254 on user devices 304 and/or IoT and data gathering devices 306 captures user activities. At the step 408, captured user activities are classified into categories and clusters by information gathering module 254.

At step 410, cloud computing system 314 receives performance data, including biometric data from hardware and software implemented on user devices 304 and/or IoT and data gathering devices 306.

If user focus is determined to be at or above a threshold “T”, then the YES branch of step 412 is followed, otherwise the NO branch of step 412 is followed, and step 410 is performed. At step 414, the cognitive processing engine 114 provides a recommendation as to an optimum alternative activity, such as a distraction or break to the user 302.

At step 416, the iterative cognitive improvement engine 116 captures category, length of time of activity and post recommendation performance. At step 418, the captured category, length of time of activity and post recommendation performance by iterative cognitive improvement engine 116 is stored as metadata to be used for feedback for optimum activity recommendation to cognitive processing engine 114. At step 420, the process 400 ends.

The following is an example scenario of how the described system and methods may be implemented. A user (e.g., user 302) writes software code for a project. The user opts in to use/implement the recommendation module 252 and information gathering module 254 (i.e., system 300) which connects to various sources, such as the user's devices (e.g., phone, smart watch, laptop, etc.). The recommendation module 252 and information gathering module 254 (i.e., system 300) integrates with user's repository hosting service, such as GITHUB′. Lines the user commits to hosting service is used a benchmark for productivity. The recommendation module 252 and information gathering module 254 (i.e., system 300) captures the user's average productivity throughout the day and uses a combination of the user's phone and smart watch (i.e., wearables) to capture break activities by detecting activity patterns, biometric data, geolocation data, and other integrated sources. Some days the user's watch captures the user going on walks as determined by a routine of walking along the office and average heartbeat increase. After going on this walk, recommendation module 252 and information gathering module 254 (i.e., system 300) detects an aggregate increase in code output. When the user's average code output begins to decrease, as determined by lack of code commits, the integrated recommendation engine 252 pushes a notification to user that the user may benefit from a walk right (distraction). After the user goes on the walk, data is re-captured to further reinforce the iterative cognitive improvement engine 116. As the user works on different activities and goes on different breaks or takes different distractions throughout the work week, the iterative cognitive improvement engine 116. captures the performance increase with regards to each method and the cognitive processing engine 114 provides tailored recommendations based on the user's schedule and current activities.

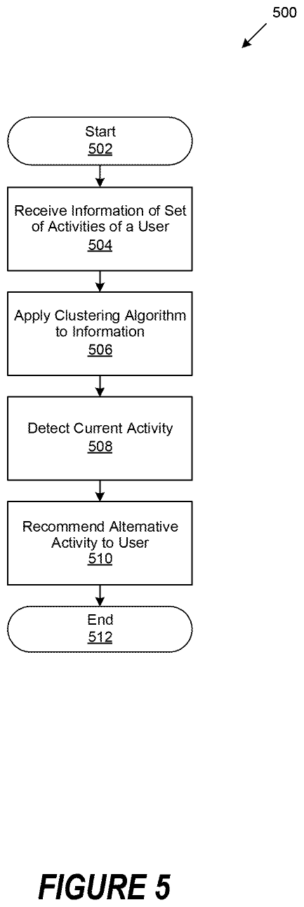

FIG. 5 is a generalized flowchart 500 for recommending an alternative activity based on an inefficiency criteria. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At step 502, the process 500 starts. At step 504 information is received from a plurality of sources related a user. The information includes a set of activities “A” defined as (A₁, A₂, . . . , Aₙ), a duration “D”, which is elapsed time, defined as (D₁, D₂, . . . , Dₙ), and a measurement of productivity associated with the activities “P” defined as (P₁, P₂, . . . , Pₙ) wherein the each activity Aᵢ has the duration Tᵢ and the productivity Pᵢ.

At step 506, clustered and classified sets of activities A is received, that include the information that are applied with a clustering algorithm to associate a cluster of types of activities and the productivity associated with the cluster of types of activity with a recommended continuous time duration.

A step 508, current activity of a user is detected. At step 510, if the current activity exceeds a recommended continuous time duration and reduction of productivity associated with the current activity, an alternative activity is recommended to the user. At step 512, the process 500 ends.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method for recommending an alternative activity comprising:
receiving information from a plurality of sources related to a user, wherein the information includes a set of activities A (A₁, A₂, . . . , Aₙ), a duration D (D₁, D₂, . . . , Dₙ) and a measurement of productivity associated with the activities P (P₁, P₂, . . . , Pₙ), wherein the each activity A₁ has the duration Tᵢ and the productivity Pᵢ;
receiving clustered and classified sets of activities A, that comprise the information that are applied with a clustering algorithm to associate a cluster of types of activities and productivity associated with the cluster of types of activity with a recommended continuous time duration; and
responsive to detecting a current activity exceeding the recommended continuous time duration and an indication of a reduction of productivity for the current activity, recommending an alternative activity to the user.

2. The method of claim 1, wherein the current activity is a programming activity and the indication of the reduction of productivity is a reduction of rate of writing code and the recommended alternative activity is to take a walk.

3. The method of claim 1, wherein the plurality of sources are selected from group consisting of Internet of Things (IoT), phones, and wearables.

4. The method of claim 1, wherein the measurement of productivity is associated with one or more key performance indicators (KPI).

5. The method of claim 1, wherein the reduction of productivity is related to user focus level set a threshold T.

6. The method of claim 1, wherein the recommending an alternative activity comprises consideration of a social score of the user.

7. The method of claim 1 further comprising gathering post recommendation data which is used to improve future recommendations.

8. A system comprising:
a processor;
a data bus coupled to the processor; and
a computer-usable medium embodying computer program code, the computer-usable medium being coupled to the data bus, the computer program code used for recommending an alternative activity executable by the processor and configured for:
receiving information from a plurality of sources related to a user, wherein the information includes a set of activities A (A₁, A₂, . . . , Aₙ), a duration D (D₁, D₂, . . . , Dₙ), and a measurement of productivity associated with the activities P₁, P₂, . . . , Pₙ), wherein the each activity Aᵢ has the duration Tᵢ and the productivity Pᵢ;
receiving clustered and classified sets of activities A, that comprise the information that are applied with a clustering algorithm to associate a cluster of types of activities and productivity associated with the cluster of types of activity with a recommended continuous time duration; and
responsive to detecting a current activity exceeding the recommended continuous time duration and an indication of a reduction of productivity for the current activity, recommending an alternative activity to the user.

9. The system of claim 8, wherein the current activity is a programming activity and the indication of the reduction of productivity is a reduction of rate of writing code and the recommended alternative activity is to take a walk.

10. The system of claim 8, wherein the plurality of sources are selected from group consisting of Internet of Things (IoT), phones, and wearables.

11. The system of claim 8, wherein the measurement of productivity is associated with one or more key performance indicators (KPI).

12. The method of claim 1, wherein the reduction of productivity is related to user focus level set a threshold T.

13. The system of claim 1, wherein the recommending an alternative activity comprises consideration of a social score of the user.

14. The system of claim 1 further comprising gathering post recommendation data which is used to improve future recommendations.

15. A non-transitory, computer-readable storage medium embodying computer program code, the computer program code comprising computer executable instructions configured for:
receiving information from a plurality of sources related to a user, wherein the information includes a set of activities A (A1, A2, . . . , An), a duration D (D₁, D₂, . . . , Dₙ), and a measurement of productivity associated with the activities P (P₁, P₂, . . . Pₙ), wherein the each activity Ai has the duration Tᵢ and the productivity Pᵢ;
receiving clustered and classified sets of activities A, that comprise the information that are applied with a clustering algorithm to associate a cluster of types of activities and productivity associated with the cluster of types of activity with a recommended continuous time duration; and
responsive to detecting a current activity exceeding the recommended continuous time duration and an indication of a reduction of productivity for the current activity, recommending an alternative activity to the user.

16. The non-transitory, computer-readable storage medium of claim 15, wherein the plurality of sources are selected from group consisting of Internet of Things (IoT), phones, and wearables.

17. The non-transitory, computer-readable storage medium of claim 15, wherein the measurement of productivity is associated with one or more key performance indicators (KPI).

18. The non-transitory, computer-readable storage medium of claim 15, wherein the reduction of productivity is related to user focus level set a threshold T.

19. The non-transitory, computer-readable storage medium of claim 15, wherein the recommending an alternative activity comprises consideration of a social score of the user.

20. The non-transitory, computer-readable storage medium of claim 15 further comprising gathering post recommendation data which is used to improve future recommendations.
